(19) United States
(12) Patent Application Publication
(10) Pub. No.: US 2017/0147564 A1
(43) Pub. Date: May 25, 2017

(54) INSTANT TRANSLATION SYSTEM, METHOD AND COMPUTER READABLE STORAGE MEDIUM FOR STORING THEREOF

(71) Applicants: Inventec (Pudong) Technology Corporation, Shanghai (CN); INVENTEC CORPORATION, TAIPEI CITY (TW)

(72) Inventor: Kai-Yun HSIEH, TAIPEI CITY (TW)

(21) Appl. No.: 15/086,041

(22) Filed: Mar. 30, 2016

(30) Foreign Application Priority Data
Nov. 24, 2015 (CN) 201510823477.4

(51) Int. Cl. G06F 17/28; G06F 3/0481; G06K 9/18; G06F 3/0485

(52) U.S. Cl. CPC G06F 17/2863; G06F 17/28; G06F 3/0485; G06F 3/04817; G06K 9/18; G06F 3/04812

(57) ABSTRACT

An instant translation system is applied on a screen displayed by a desktop program with a cursor located on the screen. The instant translation system includes a frame production module, an optical character recognition (OCR) module and a translation module. The frame production module is configured to produce an adjustable frame at a position where the cursor is located. The optical character recognition module is configured to utilize an optical character recognition program to recognize at least one word in the adjustable frame. The translation module is configured to instantly translate the word.

### RELATED APPLICATIONS

This application claims priority to Chinese Application Serial Number 201510823477.4, filed Nov. 24, 2015, which is herein incorporated by reference.

### BACKGROUND

Technical Field

The present disclosure relates to an instant translation system, method and a computer translation program. More particularly, the present disclosure relates to an instant translation system, method and a computer readable storage medium.

Description of Related Art

With the rapid development of the Internet and the deep exchanges between different cultures of different countries worldwide in different levels, more than one kind of language is easily involved in the transmission of messages nowadays. As a result, the demand for the instant translation of words has been increasing.

In the application of electronic devices, since the words can appear in a variety of forms, such as pure words, symbols in pictures or photos, Internet hyperlinks, or locked formats to prevent the words from being copied etc., a convenient way to instantly translate these various forms of words can be beneficial to the user.

### SUMMARY

A technical aspect of the present disclosure provides an instant translation system unrestricted by the forms of presentation of the words.

According to an embodiment of the present disclosure, an instant translation system is applied on a screen displayed by a desktop program with a cursor located on the screen. The instant translation system includes a frame production module, an optical character recognition (OCR) module and a translation module. The frame production module is configured to produce an adjustable frame at a position where the cursor is located. The optical character recognition module is configured to utilize an optical character recognition program to recognize at least one word in the adjustable frame. The translation module is configured to instantly translate the word.

In one or more embodiments of the present disclosure, the frame production module is configured to adjust a size of the adjustable frame according to a number parameter of the word.

In one or more embodiments of the present disclosure, the frame production module is configured to automatically adjust the number parameter according to a preset program.

In one or more embodiments of the present disclosure, the frame production module is configured to adjust the number parameter according to a roller scrolling command.

In one or more embodiments of the present disclosure, the frame production module is activated according to a signal of a first click and produces the adjustable frame when the cursor moves to an instant translation icon on the screen.

In one or more embodiments of the present disclosure, the frame production module cancels the adjustable frame according to a signal of a second click.

According to another embodiment of the present disclosure, an instant translation method is applied on a screen displayed by a desktop program with a cursor located on the screen. The instant translation method includes the following steps (it is appreciated that the sequence of the steps and the sub-steps as mentioned below, unless otherwise specified, can all be adjusted upon the actual needs, or even executed at the same time or partially at the same time):

(1) producing an adjustable frame at a position where the cursor is located.

(2) utilizing an optical character recognition program to recognize at least one word in the adjustable frame.

(3) translating the word instantly.

In one or more embodiments of the present disclosure, the step (1) includes the following sub-step:

(1.1) adjusting a size of the adjustable frame according to a number parameter of the word.

In one or more embodiments of the present disclosure, the sub-step (1.1) includes the following sub-sub-step:

(1.1.1) adjusting the number parameter automatically according to a preset program.

In one or more embodiments of the present disclosure, the sub-step (1.1) includes the following sub-sub-step:

(1.1.2) adjusting the number parameter according to a roller scrolling command.

In one or more embodiments of the present disclosure, the step (1) includes the following sub-step:

(1.2) producing the adjustable frame according to a signal of a first click when the cursor moves to an instant translation icon on the screen.

According to another embodiment of the present disclosure, a computer readable storage medium for storing a computer program to execute an instant translation method is provided. The instant translation method is applied on a screen displayed by a desktop program with a cursor located on the screen. The instant translation method includes the following steps (it is appreciated that the sequence of the steps and the sub-steps as mentioned below, unless otherwise specified, can all be adjusted upon the actual needs, or even executed at the same time or partially at the same time):

(1) producing an adjustable frame at a position where the cursor is located.

(2) utilizing an optical character recognition program to recognize at least one word in the adjustable frame.

(3) translating the word instantly.

When compared with the prior art, the above-mentioned embodiments of the present disclosure have at least the following advantages:

(1) Since the optical character recognition module utilizes the optical character recognition program to recognize the word in the adjustable frame, the effect that the word being recognized is not restricted by the form of presentation of the word. For example, even if the word is presented in the forms such as figures, hyperlinks, locked formats to prevent the word from being copied, the optical character recognition module can still utilize the optical character recognition program to recognize the word in the adjustable frame. Then, the translation module instantly translates the word recognized by the optical character recognition module. As a result, the instant translation system can instantly translate any form of the word on the screen, making it convenient to the user.
(2) The frame production module is activated according to a signal of a first click and produces the adjustable frame when the cursor moves to an instant translation icon (not shown) on the screen. After the adjustable frame is produced, the frame production module can cancel the adjustable frame according to a signal of a second click. In this way, the switching on and the switching off of the frame production module can be carried out in a simple and easy way, leading to further convenience for the user.

### BRIEF DESCRIPTION OF THE DRAWINGS

The disclosure can be more fully understood by reading the following detailed description of the embodiments, with reference made to the accompanying drawings as follows:

FIG. 1 is a schematic diagram of an instant translation system according to an embodiment of the present disclosure;

FIGS. 2-3 are application diagrams of the instant translation system of FIG. 1 on a screen displayed by a desktop program;

FIG. 4 is a flow chart of an instant translation method according to an embodiment of the present disclosure;

FIG. 5 is a flow chart of an instant translation method according to another embodiment of the present disclosure; and

FIG. 6 is a flow chart of an instant translation method according to a further embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

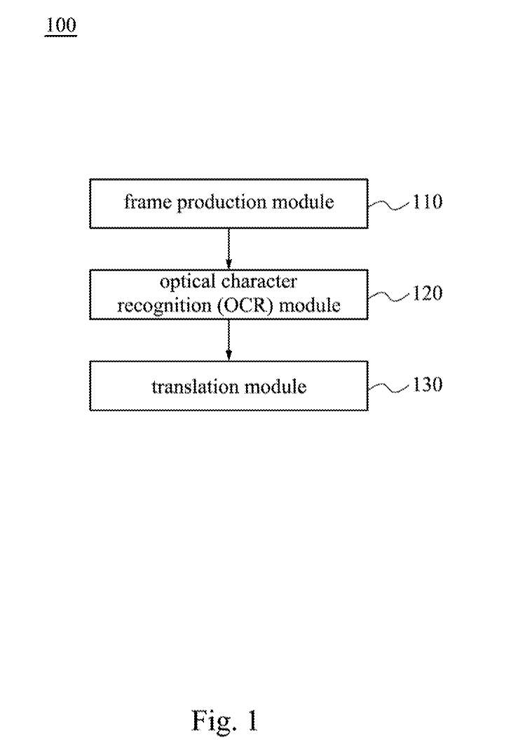

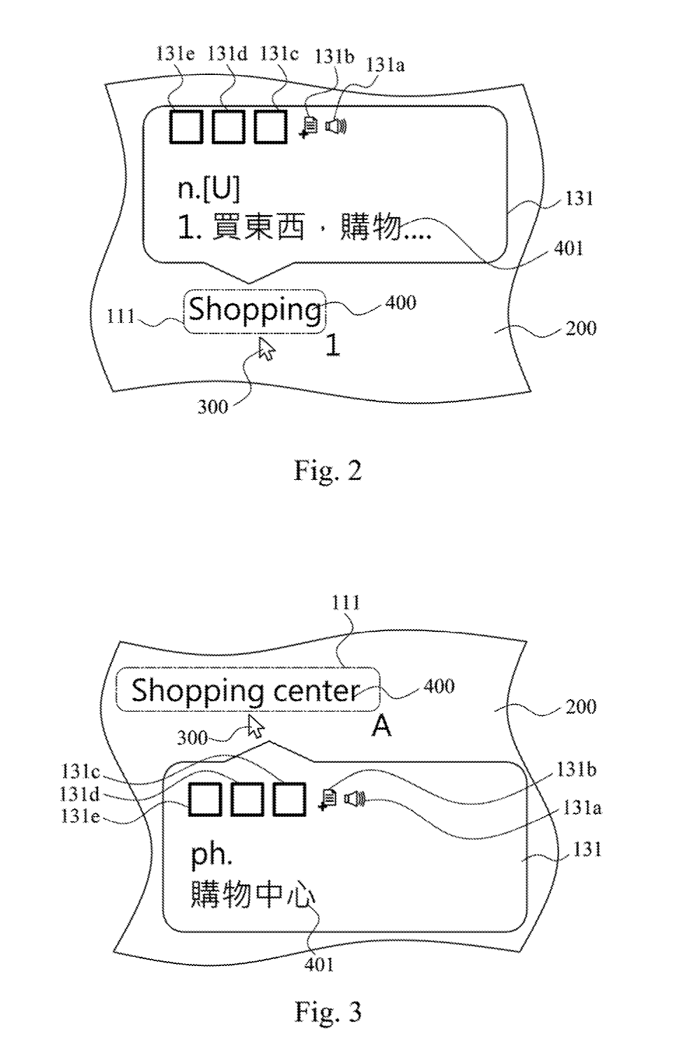

Reference is made to FIGS. 1-3. FIG. 1 is a schematic diagram of an instant translation system 100 according to an embodiment of the present disclosure. FIGS. 2-3 are application diagrams of the instant translation system 100 of FIG. 1 on a screen 200 displayed by a desktop program. As shown in FIGS. 1-3, an instant translation system 100 is applied on a screen 200 displayed by a desktop program with a cursor 300 located on the screen 200. The instant translation system 100 includes a frame production module 110, an optical character recognition (OCR) module 120 and a translation module 130. The frame production module 110 is configured to produce an adjustable frame 111 at a position where the cursor 300 is located. The optical character recognition module 120 is configured to utilize an optical character recognition program to recognize at least one word 400 in the adjustable frame 111. The translation module 130 is configured to instantly translate the word 400. In this embodiment, the adjustable frame 111 formed by dotted lines. However, in practical applications, apart from dotted lines, the adjustable frame 111 can also be presented by other figures such as the shape of “L” located at the four corners of the adjustable frame 111 or the shape of a magnifying glass.

In other words, as shown in FIGS. 2-3, when the cursor 300 stops on the word 400 on the screen 200, the frame production module 100 produces the adjustable frame 111 at the position where the cursor 300 is located (for example, right at the top of the cursor 300), and the word 400 is located in the adjustable frame 111. After the adjustable frame 111 is produced, the optical character recognition module 120 utilizes the optical character recognition program to recognize the word 400 in the adjustable frame 111. Then, the translation module 130 instantly translates the word 400 recognized by the optical character recognition module 120. The instant translation refers to the translation of the word 400 by the optical character recognition module 120 in a time period equal to or less than 1 second. Since the optical character recognition module 120 utilizes the optical character recognition program to recognize the word 400 in the adjustable frame 111, the effect that the word 400 being recognized is not restricted by the form of presentation of the word 400. For example, even if the word 400 is presented in the forms such as figures, hyperlinks, locked formats to prevent the word 400 from being copied, the optical character recognition module 120 can still utilize the optical character recognition program to recognize the word 400 in the adjustable frame 111. Then, the translation module 130 instantly translates the word 400 recognized by the optical character recognition module 120. As a result, the instant translation system 100 can instantly translate any form of the word 400 on the screen 200, making it convenient to the user.

To be more specific, as shown in FIGS. 2-3, the translation module 130 produces a translation window 131 on the screen 200. The translated word 401 instantly translated by the translation module 130 is located in the translation window 131. In this embodiment, the translation window 131 can be displayed at the top or the bottom of the adjustable frame 111 on the screen 200 according to the setting, so as to facilitate the user to read. For example, if the word 400 to be translated is located at the lower part of the screen 200, the translation window 131 can be set to be displayed at the top of the adjustable frame 111. On the contrary, if the word 400 to be translated is located at the upper part of the screen 200, the translation window 131 can be set to be displayed at the bottom of the adjustable frame 111.

Furthermore, the translation window 131 further has some function keys to be conveniently used according to the actual needs of the user. For example, as shown in FIGS. 2-3, at least one of the function keys can be a speaker key 131a. When the user activates the speaker key 131a, the translation module 130 will make the pronunciation element (not shown) already set to pronounce according to the translated word 401. Moreover, at least one of the function keys can be a copying key 131b. When the user activates the copying key 131b, the translation module 130 will copy the translated word 401 to a clipboard already set in advance. In addition, the function keys can include a storage key 131c. When the user activates the storage key 131c, the translation module 130 will put the translated word 401 to the notebook already set in advance.

On the other hand, in order to obtain more information about the translated word 401, as shown in FIGS. 2-3, at least one of the function keys can be a function key linked up with other databases, such as the dictionary database linkage key 131d or the online translation website linkage key 131e etc. When the user activates the dictionary database linkage key 131d, the translation module 130 will link up with the dictionary database instantly, and search for any relevant information in the dictionary database about the word 400 or the translated word 401. When the user activates the online translation websites linkage key 131e, the translation module 130 will link up with an online translation website instantly, and search for any relevant information in the online translation website about the word 400 or the translated word 401. In this embodiment, the online translation websites linkage key 131e can make the translation module 130 linked up with Google. In other embodiments, the online translation websites linkage key 131e can make the translation module 130 linked up with other online translation websites.

Since the number of the word 400 on the screen 200 can be more than one, the frame production module 110 can adjust a size of the adjustable frame 111 according to a number parameter of the word 400, so as to facilitate operation for the user. For example, as shown in FIG. 2, the number parameter is set to be 1 and is displayed on the right bottom corner of the adjustable frame 111 in FIG. 2. In this way, the adjustable frame 111 frames up one unit of the word 400. The word 400 in FIG. 2 is an English word “shopping”. The optical character recognition module 120 utilizes the optical character recognition program to recognize the word 400, i.e., the English word “shopping”. Then, the translation module 130 instantly translates the word 400, i.e., the English word “shopping”. In the practical applications, the number parameter can be set to integrals such as 1, 2, 3 and 4, etc.

In practical applications, in this embodiment, the frame production module 110 can automatically adjust the number parameter according to a preset program. For example, as shown in FIG. 3, the number parameter is set to be automatic, and an “A” is displayed on the right bottom corner of the adjustable frame 111 in FIG. 3. In this way, the adjustable frame 111 automatically frames up an appropriate unit(s) of the word 400. The word 400 in FIG. 3 is an English phrase “shopping center”. The optical character recognition module 120 utilizes the optical character recognition program to recognize the word 400, i.e., the English phrase “shopping center”. Then, the translation module 130 instantly translates the word 400, i.e., the English phrase “shopping center”.

On the other hand, according to the actual needs, the user can make the frame production module 110 adjust the number parameter according to a roller scrolling command. For example, the roller can be the roller on a mouse. Through the scrolling of the roller on the mouse by the user, the number parameter can be switched between A (i.e., automatic) and integrals like 1, 2, 3, 4, etc. according to the actual needs, leading to further convenience for the user.

In this embodiment, the frame production module 110 is activated according to a signal of a first click and produces the adjustable frame 111 when the cursor 300 moves to an instant translation icon (not shown) on the screen 200. After the adjustable frame 111 is produced, the frame production module 110 can cancel the adjustable frame 111 according to a signal of a second click. In this way, the switching on and the switching off of the frame production module 110 can be carried out in a simple and easy way, leading to further convenience for the user. To be more specific, the first click can be the command that the user presses on the left button of the mouse when the cursor 300 is located at the instant translation icon. On the other hand, the second click can be the command that the user presses on the left button of the mouse when the adjustable frame 111 is produced.

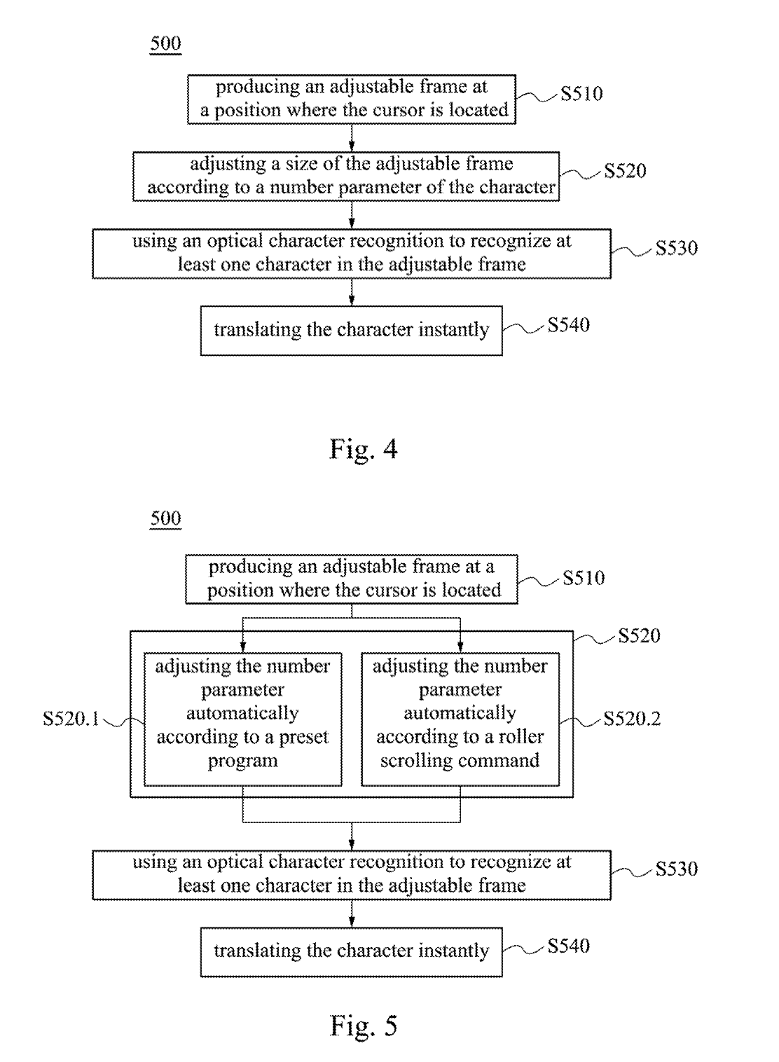

Reference is made to FIG. 4. FIG. 4 is a flow chart of an instant translation method 500 according to an embodiment of the present disclosure. In another aspect of the present disclosure, a computer readable storage medium is provided. The instant translation method 500 can be a computer program stored in the computer readable storage medium, which makes a computer to read this storage medium and execute the instant translation method 500. The computer readable storage medium can be a read only memory, flash memory, floppy disk, hard disk, compact disc, flash drive, magnetic tape, database storable on the Internet, or a computer readable storage medium with similar functions that people having ordinary skill in the art can easily think of. The instant translation method 500 is applied on the screen 200 displayed by the desktop program with the cursor 300 located on the screen 200. As shown in FIG. 4, the instant translation method 500 includes the following steps (it is appreciated that the sequence of the steps and the sub-steps as mentioned below, unless otherwise specified, can all be adjusted upon the actual needs, or even executed at the same time or partially at the same time):

(1) producing the adjustable frame 111 at the position where the cursor 300 is located (Step S510).

(2) adjusting the size of the adjustable frame 111 according to the number parameter of the word 400 (Step S520).

(3) utilizing an optical character recognition program to recognize at least one word 400 in the adjustable frame 111 (Step S530).

(4) translating the word 400 instantly (Step S540).

Reference is made to FIG. 5. FIG. 5 is a flow chart of an instant translation method 500 according to another embodiment of the present disclosure. As mentioned above, since the number of the word 400 on the screen 200 can be more than one, in order to facilitate the user to operate, as shown in FIG. 5, the Step S520 further includes the following sub-steps:

(2.1) adjusting the number parameter automatically according to the preset program (Step 520.1).

(2.2) adjusting the number parameter according to the roller scrolling command (Step 520.2).

In this way, the user can automatically adjust or instantly switch the number of word 400 to be translated in a simple and easy way according to the actual needs, leading to further convenience for the user.

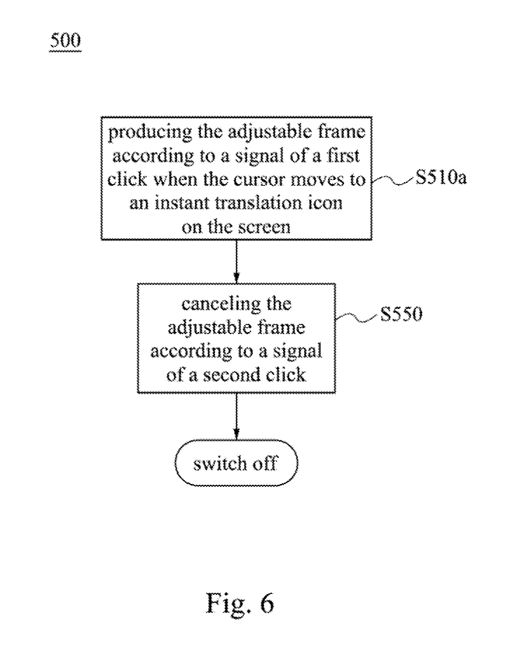

Reference is made to FIG. 6. FIG. 6 is a flow chart of an instant translation method 500 according to a further embodiment of the present disclosure. In addition, in order to allow the switching on of the frame production module 110 to be carried out in a simple and easy way for further convenience for the user, as shown in FIG. 6, a detailed description of the Step S510 is:

(1a) Producing the adjustable frame 111 according to the signal of the first click when the cursor 300 moves to an instant translation icon (not shown) on the screen 200 (Step S510a).

On the other hand, in order to allow the switching off of the frame production module 110 to be carried out in a simple and easy way for further convenience for the user, as shown in FIG. 6, the instant translation method 500 further includes:

(1.5) Canceling the adjustable frame 111 according to the signal of the second click (Step S550).

After the adjustable frame 111 is cancelled according to the signal of the second click, the frame production module 110 and thus the instant translation system 100 is switched off. To be more specific, the first click can be the command that the user presses on the left button of the mouse when the cursor 300 is located at the instant translation icon. On the other hand, the second click can be the command that the user presses on the left button of the mouse when the adjustable frame 111 is produced.

In conclusion, when compared with the prior art, the embodiments of the present disclosure mentioned above have at least the following advantages:

(1) Since the optical character recognition module utilizes the optical character recognition program to recognize the word in the adjustable frame, the effect that the word being recognized is not restricted by the form of presentation of the word. For example, even if the word is presented in the forms such as figures, hyperlinks, locked formats to prevent the word from being copied, the optical character recognition module can still utilize the optical character recognition program to recognize the word in the adjustable frame. Then, the translation module instantly translates the word recognized by the optical character recognition module. As a result, the instant translation system can instantly translate any form of the word on the screen, making it convenient to the user.
(2) The frame production module is activated according to a signal of a first click and produces the adjustable frame when the cursor moves to an instant translation icon on the screen. After the adjustable frame is produced, the frame production module can cancel the adjustable frame according to a signal of a second click. In this way, the switching on and the switching off of the frame production module can be carried out in a simple and easy way, leading to further convenience for the user.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. An instant translation system applied on a screen displayed by a desktop program with a cursor located on the screen, the instant translation system comprising:
a frame production module configured to produce an adjustable frame at a position where the cursor is located;
an optical character recognition (OCR) module configured to utilize an optical character recognition program to recognize at least one word in the adjustable frame; and
a translation module configured to instantly translate the word.

2. The instant translation system of claim 1, wherein the frame production module is configured to adjust a size of the adjustable frame according to a number parameter of the word.

3. The instant translation system of claim 2, wherein the frame production module is configured to automatically adjust the number parameter according to a preset program.

4. The instant translation system of claim 2, wherein the frame production module is configured to adjust the number parameter according to a roller scrolling command.

5. The instant translation system of claim 1, wherein the frame production module is activated according to a signal of a first click and produces the adjustable frame when the cursor moves to an instant translation icon on the screen.

6. The instant translation system of claim 1, wherein the frame production module cancels the adjustable frame according to a signal of a second click.

7. An instant translation method applied on a screen displayed by a desktop program with a cursor located on the screen, the instant translation method comprising:
producing an adjustable frame at a position where the cursor is located;
utilizing an optical character recognition program to recognize at least one word in the adjustable frame; and
translating the word instantly.

8. The instant translation method of claim 7, wherein the step of producing the adjustable frame at the position where the cursor is located comprises:
adjusting a size of the adjustable frame according to a number parameter of the word.

9. The instant translation method of claim 8, wherein the step of adjusting the size of the adjustable frame according to the number parameter of the word comprises:
adjusting the number parameter automatically according to a preset program.

10. The instant translation method of claim 8, wherein the step of adjusting the size of the adjustable frame according to the number parameter of the word comprises:
adjusting the number parameter according to a roller scrolling command.

11. The instant translation method of claim 7, wherein the step of producing the adjustable frame at the position where the cursor is located comprises:
producing the adjustable frame according to a signal of a first click when the cursor moves to an instant translation icon on the screen.

12. A computer readable storage medium for storing a computer program to execute an instant translation method, the instant translation method applied on a screen displayed by a desktop program with a cursor located on the screen, the instant translation method comprising:
producing an adjustable frame at a position where the cursor is located;
utilizing an optical character recognition (OCR) program to recognize at least one word in the adjustable frame; and
translating the word instantly.
